(19) United States
(12) Patent Application Publication
(10) Pub. No.: US 2009/0205789 A1
(43) Pub. Date: Aug. 20, 2009

(54) CELLULAR WINDOW SHADE

(76) Inventors: RICHARD D. WATKINS, Lake Luzerne, NY (US); James Barss, Porter Corners, NY (US); Rodney Akers, Clifton Park, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/371,610

(22) Filed: Feb. 15, 2009

Related U.S. Application Data
(60) Provisional application No. 61/029,201, filed on Feb. 15, 2008.
(60) Provisional application No. 61/030,164, filed on Feb. 20, 2008.

(51) Int. Cl. E06B 9/30; B21D 47/00

(52) U.S. Cl. 160/173 R; 29/433; 29/897

(57) ABSTRACT

A window covering includes at least one pair of cell-supporting cords comprising a first support cord supporting an upper portion of each cell and a second support cord supporting a lower portion of each cell. The collapse and expansion of each cell is accomplished by the respective raising and lowering of the second support cord without movement of the first support cord.

### CROSS-REFERENCE TO RELATED APPLICATIONS

This Application is a Non-Prov of Prov (35 USC 119(e)) application 61/029,201 filed on Feb. 15, 2008 and application 61/030,164 filed on Feb. 20, 2008.

### BACKGROUND

Venetian-style, expandable/collapsible cellular window shades typically have tubular vanes made stiff along their length to avoid sagging when supported by spaced cords. Hinging areas between stiffened regions enable the tube to be collapsed or expanded, despite the lengthwise stiffening, and control the shape of the cell that results when the tubular vane is expanded.

The tubular vane shade requires cording which is not fore-and-aft, as in conventional Venetians for tilting fore-and-aft, but rather in-plane, for central, balanced lifting and lowering of the upper and lower portions of each cell. Further, the cords must engage either the upper or lower portion of each tubular slat-cell, with some cords engaging only uppers and others engaging only lowers. To remain on the centerplane only, the cords must pass through an opening in each slat, rather than over the slats as is possible with conventional fore-and-aft arrangements. Conventional ladder cords are not only fore-and-aft in orientation, but only support each slat from its lower surface.

For tubular-slat shades, a series of beads or other regularly-spaced attachment devices can be attached to the cords for interfacing with each slat, but a method and means are required for manufacturing the shade economically and rapidly from initially separate stacks of slats and continuous cord supplied from reels. In the U.S. Pat. No. 6,618,400 patent, for example, the cords are produced with uniformly spaced beads attached to the cord before it is supplied in reels for engagement with slats. There, beaded cords were attached to the respective upper and lower portions of each slat, but only after a full complement of slats for a complete window shade had been made. This technique required engagement features (e.g., specially shaped holes) in both top and bottom surfaces of the cells, as well as free-passage features (clearance holes) where cords and their beads are not to engage. The features on the top and bottom surfaces are typically not identical in any location, but must be aligned precisely to allow non-binding and non-wearing movements of the cords.

In practice, the manufacture of such beaded cords to the close tolerance in spacing variations required for uniform appearance and operation has proven costly. The insertion and retention of the many beads in their respective engagement features has proven difficult to achieve with certainty. These shortcomings have lead to excessive product cost and limited manufacturing speed and product acceptance.

### BRIEF DESCRIPTION OF THE DRAWINGS

FIG. 1 is an exploded perspective view of a novel window blind assembly.

FIG. 2 is an enlarged perspective view of a portion of an individual cell of the assembly of FIG. 1, showing the associated cords, with a portion of the cell wall broken away to reveal the cell interior.

FIG. 3 is a perspective view of a cell wall lifter used in the assembly embodiment of FIG. 1.

FIG. 4A is a plan view of a portion of an elongated laminated strip from which the cells of FIG. 1 are formed.

FIG. 4B is an end view of the laminated strip of FIG. 4A after it has been folded and bonded to form the closed cell of FIG. 1.

FIG. 5 is an enlarged exploded perspective view of the upper portion of the window blind assembly of FIG. 1.

### DETAILED DESCRIPTION

Disclosed herein is an improved construction and associated method and implementing apparatus for a kind of Venetian-style window shade wherein the individual light-control elements, which may be called vanes or cells or slats, that in a conventional Venetian blind tilt around their long axis to control light passage, are here instead expanded and contracted to alter their light-blocking effect. In their expanded condition, such slats have a tubular or cellular form, and at their maximum expansion, come into contact with adjacent elements to form a fully closed (i.e., view-obstructing) cellular shade. Such an actuation requires that the cords which space and move the multiple individual slats must separately address and engage the upper and lower surfaces of those slats, enabling the cords to control the position of those surfaces and thereby expand and collapse the cell-slats.

The improved method of manufacture disclosed here still enables such slat-cells to be made from flat goods for economy (and adds an in-process coloring step to further lower cost and expand aesthetic range), and provides a less-costly means for separately addressing and engaging the upper and lower portions thereof with cords that are beaded after the slat-cells are fully manufactured. The present invention also includes a less-costly operating means, which nonetheless assures more perfect cell-to-cell closure, resulting in improved aesthetic value and insulating effect of the finished product.

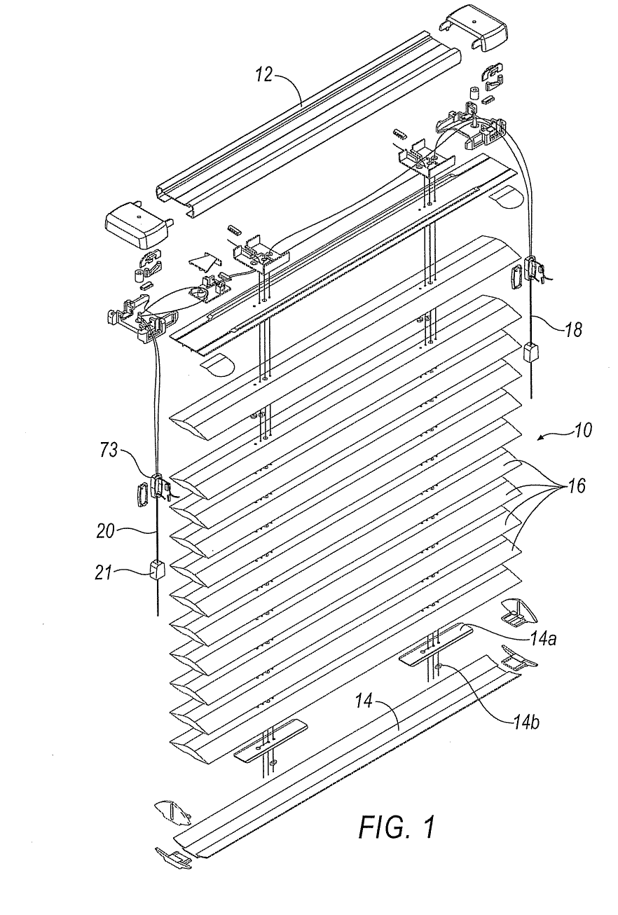

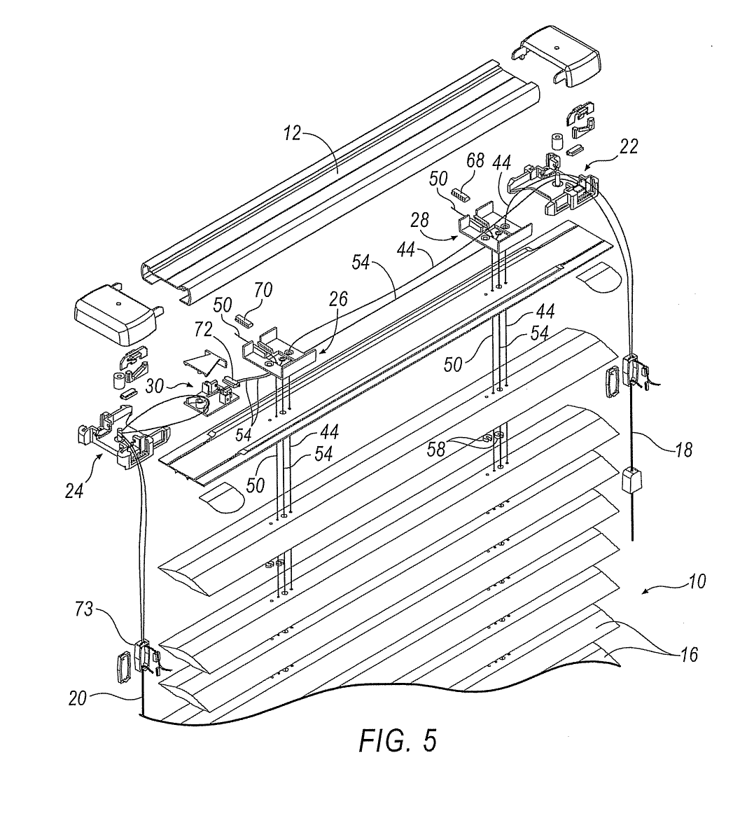

FIG. 1 is an exploded view of an entire window blind assembly 10 incorporating embodiments of the present invention. Assembly 10 generally comprises head and bottom rails 12, 14, respectively, an array of identical cells 16, lift cord 18 and actuator cord 20 provided with hand grip tassel 21. Within head rail 12 (as best shown in the enlarged view of FIG. 5) are mounted a pair of cord locks 22, 24, a pair of cord guide sets 26, 28 and a longitudinally slidable block and tackle-like device 30. It is contemplated that the illustrated pair of cord guides (and associated cord groupings) will likely be the minimum number required for relatively narrow window blinds. To prevent excessive vane sag over long spans of window blinds, those skilled in the art will recognize that a greater number of these elements will be required.

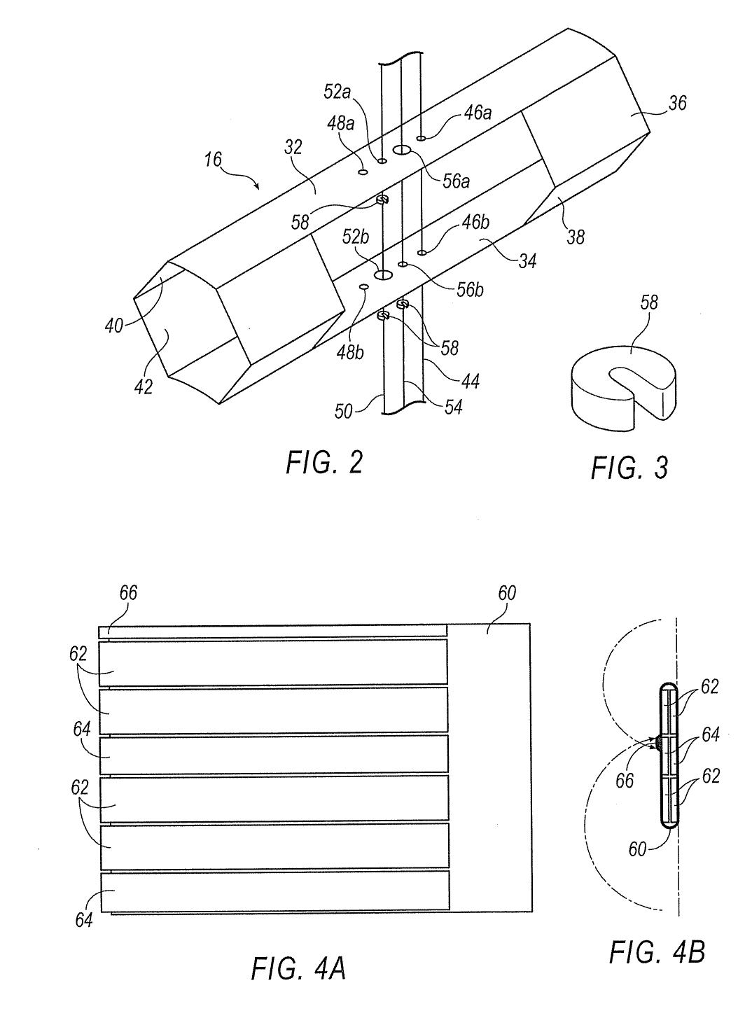

A simplified perspective view of a portion of an individual cell 16 and one set of its associated cords is shown in FIG. 2, wherein portions of the side walls are broken away to show the cell interior. Cell 16 generally comprises top and bottom walls 32, 34, respectively, and four side walls 36, 38, 40 and 42. Top and bottom walls 32, 34 are provided with at least two longitudinally spaced sets of cord passage holes (only one such set being shown), depending upon the width of the window opening and length of the cells. Each set of cord passage holes permits passage of a lift cord 44 through either of two pairs of vertically aligned lift cord holes 46a, 46b or 48a, 48b; top wall support cord 50 through a pair of vertically aligned holes 52a, 52b; and bottom wall actuator cord 54 through a pair of vertically aligned holes 56a, 56b. The holes are placed along the longitudinal midline of the top and bottom walls, and the minimal radial clearance between the unbeaded lifter cords 44 and small-diameter holes 46a,46b prevents undesired tilting of the cells about their its longitudinal axes.

Lift cords 44 are a continuation of lift cord 18 (FIGS. 1 and 5) and are anchored to bottom rail 14 or bottom rail attachment strip 14a, such as by washer 14b, so that the entire blind assembly may be lifted and lowered as a unit to any desired position within the window opening. Two pairs of lift cord holes are provided in each set of eight holes so that the appropriate pair can be selected for either left-hand or right-hand lift cord installations.

Lifter elements 58 (FIGS. 2 and 3) are crimped onto top wall support cord 50 and bottom wall support cord 54 at predetermined spaced intervals, as will be more fully described below. As shown in FIG. 3, lifter elements may be formed by punching a generally C-shaped plug from a plate of material, such as aluminum, the material and size being chosen to permit the plugs to receive a cord laterally through the opening between the arms of the “C,” and then be squeezed or crimped around the cord for permanent attachment thereto at predetermined and permanent locations. As best shown in FIG. 2, the sizes of holes 52a, 52b are selected so that top wall support cord 50 and its crimped-on lifters 58 can freely pass through the larger hole 52b in cell bottom wall 34, but cannot pass through the smaller hole 52a in cell top wall 32. In that way, lifters 58 on top wall support cord 50 abut and support the underside of the top wall 32 of each cell 16. Conversely, the sizes of holes 56a and 56b are selected so that bottom wall support cord 54 and its crimped-on lifters 58 can freely pass through top wall hole 56a, but will abut and support the underside of bottom wall 34 of each cell. The enlarged holes permit the lifters on cords 54 and 50 to enter a cell from above or below, respectively, during assembly of the beaded cords to the cells, as will be further explained below. In the case of bottom support cord 54, lifters 58 pass through large holes 56a in top wall 32 of the next lower cell in cell conditions approaching full expansion. That is, when full cell expansion is desired (i.e., full closure of the window blind), lifters 58 on bottom support cords 54 must descend into the interior of the next adjacent lower cell, to avoid blocking bottom wall 34 of each cell from freely resting on top wall 32 of the next adjacent lower cell.

FIGS. 4A and 4B illustrate one exemplary structure for the cell pre-form. The pre-form comprises an elongated strip of flexible, non-stiffened, preferably knitted fabric 60, preferably supplied as a continuous strip from a roll of common white goods (not illustrated). The fabric on the supply roll already has laminated to it six parallel and laterally spaced longitudinal strips. Four strips 62 comprise stiffened fabric material and two strips 64 comprise thermoformable polymer. Preferably, polymeric materials of matching thermal expansion rate are used for the fabric and all of the strips, to minimize thermal distortion when the cells experience changing temperatures. Strips 62, which form cell side walls 36, 38, 40 and 42, may be stiffened by applying a curable stiffening compound. Top and bottom walls of the completed cell 16 are formed by thermoformable polymer strips 64, which are preferably formed with a cambered transverse cross-section, as shown in FIG. 2. That is, those walls are formed with matching curvatures, for purposes explained below. These thermoformable strips 64 are preferably formed by infusing the thermoformable polymer into a non-woven fibrous matrix. The thermoformable polymer strips 64 are preferably translucent to allow some light passage, to thereby avoid aesthetically undesirable shadow lines that are created by opaque metallic cell stiffeners. The spaces between strips 62 and 64 (FIG. 4A), where there is only unstiffened fabric 60, provide living hinge lines that permit the cells to expand under the cells' own weight when bottom wall support cord 54 is lowered, and also cause the cell to collapse in controlled fashion when bottom support cord 54 is raised. Preferably, fabric 60 has any desired coloration and print pattern applied to it (as by digitally controlled inkjets) after the lamination step and as part of the described process of forming the cells, so that it is not necessary to stock rolls of pre-colored and patterned material.

The camber is created by passing the strips through a first straight-across slot passage that is heated to the softening-forming temperature of the stiffener, and then through a chilled and cambered (i.e., curved) slot passage that sets the newly formed shapes before release. Optionally, a forming roll set may also be added between the two slots to pre-form the hot, flat strips before they enter the chilled passage. The camber serves two purposes. First, it provides added longitudinal bending stiffness to each cell, thereby minimizing the number of pairs of support cords 50,54 needed along the length of the cells in a given window shade. Second, the matching cambers of the bottom wall of one cell with the top wall of the next lower cell permit adjacent cells to nest when in their fully expanded condition, further assuring that light-admitting straight-through gaps will not exist in that condition.

Those skilled in the art will appreciate that other cell cross-sectional profiles could be utilized, while still incorporating features of the present invention such as those disclosed in commonly-owned U.S. Pat. Nos. 5,680,891 (Prince), 5,733,632 (Marusal), 5,918,655 (Corey), 6,786,268 (Corey et al.) and 6,817,400 (Corey et al).

The gaps between strips 62 and between strips 62 and 64, which comprise unstiffened fabric 60, function as living hinges, allowing the pre-form to be folded into a tubular shape, as shown in FIG. 4B. A closure seal 66, preferably a cyanoacrylate adhesive, is provided between opposing edges of the pre-form to retain the cell in its tubular form. Alternatively, double-sided tape could be used to connect the opposing edges. The closure may be in the form of an overlapping joint, as illustrated, or a butt-type joint.

Following the thermoforming of the top and bottom walls, and before the necessary folding and joining step, the previously described holes are punched in the top and bottom walls 32, 34 of the still-unfolded strip. The previously described four-hole groupings of these holes are spaced at pre-determined intervals along the length of the laminated web, based upon the desired dimensions of the finished window blind.

After the hole-punching step, laminated web passes through a conventional series of guides that fold the web along at least two predetermined hinge lines into the configuration shown in FIG. 4B. The now-closed cell is fed into a shearing machine, where it is cut to predetermined lengths, the location of the cell ends being coordinated with the position of the hole groupings. To accomplish that step, the position of the cell can be determined by monitoring the position of the hole groupings, using, for example, a conventional encoder located on pulling rolls positioned in-line between the hole-punching station and the shearing machine. The cut-to-length individual cells are then ready for stacking and assembly to the cords.

A method and apparatus for accomplishing that assembly step will now be described. The stringing of the cords is preferably accomplished by placing the necessary complement of individual cells for a particularly sized window into a vertical stack on a fixture, with the pre-formed holes in vertical alignment, just as they would be when installed in a window. The cells are initially fully collapsed, so that the height of the stack is relatively small. The plain, unbeaded cords are fed from spools located beneath the fixture, the spools being movable laterally (i.e., parallel to the longitudinal axis of the cells) as necessary to align the cords with the particular hole grouping spacing of the shade being assembled. The individual cords are fed upwardly through the aligned holes and their upper ends secured to a vertically movable top rail initially located immediately above the collapsed stack.

Next, vacuum grippers are positioned to engage the top cell of the stack and lift it along the cords and away from the remainder of the stack a distance more than the height of a fully open cell. A pair of laterally and vertically spaced crimping heads, each holding one of the C-shaped lifters 58, advances into the space created between the lifted cell and the topmost of the remaining collapsed cells of the stack. The spacing corresponds with the desired vertical distance between the two lifters for a given cell and the horizontal distance between the two lifter cords 50,54 (FIG. 2). The crimping heads are fed from a conventional vibratory feeder and magazine carrying a supply of the lifters. Once the lifters are crimped onto the cords, the top rail (with the top end of the cords secured thereto) is indexed upwardly the appropriate distance to position the cords at the proper elevation for the next pair of lifters to be crimped thereto at a predetermined interval from the previously crimped pair of lifters. The crimping heads are withdrawn to permit the vacuum grippers to engage and lift the next collapsed cell from the stack, the lift height once again being more than the height of a fully open cell, to permit the crimping heads to advance into the space and perform the lifter crimping step. This sequence then repeats until the lifters have been crimped onto the cords beneath the last remaining cell of the original stack of collapsed cells. The assembled stack of cells and cords is then ready for assembly to the bottom and top rails, as illustrated in FIG. 1.

This method of assembling the cells to the control cords and applying the lifters to the cords provides improved repeatability and uniformity of lifter positioning and spacing across all of the control cords. The cell-raising and top rail/control cord-raising steps can be implemented by air cylinders with precisely controlled and repeatable strokes, and the lifter-crimping mechanism can be at a constant height in the assembly apparatus, thereby assuring maximum accuracy for these important assembly steps. Furthermore, this stringing method applies the lifters or beads under uniform, as-installed, cord tension, avoiding prior art cord-beading problems wherein variances in cord stretch rates readily results in variable bead pitch and therefore unsightly non-uniform gaps between the cells or vanes.

Referring once again to the operation of the disclosed window blind, this blind differs from that disclosed in previously mentioned U.S. Pat. No. 6,786,268, for example, especially in that the expansion and collapse of the cells (together, the “actuation”) is accomplished solely by lifting the lower parts or alternately by lowering the upper parts of the cells to collapse them, rather than doing both at once. Unlike previously known and disclosed embodiments of cellular-Venetian blinds, where the tops and bottoms of the cells were moved in substantially equal but opposite amounts, to preserve the overall mass centers and thereby avoid loads in the actuator, the new hardware accepts these loads by working only on the cell bottoms, lifting them to collapse the cells for view-through between the cells, and releasing them to allow cells to settle into contact for insulation, room darkening or privacy. Lifting the lower parts to collapse the cells has the further advantage of needing no actuating forces in those cords when the cells are expanded, making complete and uniform contact between adjacent cells largely independent of the accuracy of those lifting actuator cord beads. That is, the lower edges are allowed to simply fall onto the tops of adjacent cells below, and the relaxed lifting beads pass freely into the lower cells.

In practice, this means that only one set of cords (either the top-supporting or the bottom-supporting cord) must be moved to actuate the cells. Accordingly, the tilting structures and slip clutches of U.S. Pat. No. 6,786,268 are not needed, and only a cord lock is required to maintain a selected actuation position, anywhere between fully collapsed and fully expanded. Because unbeaded cords to which lifting/supporting elements are applied during assembly to the cells (and then only to the portion of the cords that engage the cells), there is no need to perform the uneconomical step of removing beads from the portion of the cords that would pass through a cord lock. For these reasons, conventional and identical cord locks can be employed for both actuator cord 18 and lift cord 20.

In the enlarged exploded view of FIG. 5, additional components of the headrail assembly 12 are illustrated. These include the cord locks 68, 70 for lift cord 18 and actuator cord 20, respectively, cord pulley set 72 and a pair of cord guide sets 26, 28. Lift cord 18 branches into two lift cords 44 that pass through cord guide sets 26, 28 and are secured to the bottom rail attachment strip 14a. The two top wall support cords 50 extend up through the cord guide sets, where they are anchored by cord locks 68, 70.

As previously noted, the illustrated window blind assembly 10 of FIGS. 1 and 5 is representative of a blind of relatively minimal span, so that only two cord guide sets 26, 28 and associated cord groupings (44,50,54) are required to support cells 16. Bottom wall support cords 54 pass upward through the cord guide sets and then horizontally to block and tackle-like device 30, where the cords are collated and secured beneath clamping element 72 and knotted behind that element. Bottom wall support cords 54 are controlled by actuator cord 20, the upper portion of which is a loop doubled upon itself to form a two-part line having its two adjacent free ends secured within safety equalizer 73. The closed end of the actuator cord loop passes upwardly through the locking pawl of cord lock 24 and then loops around a curved bearing surface in block and tackle device 30. Downward pull on actuator cord 20 causes such device 30 to slide longitudinally within headrail 12 and toward cord lock 24, to thereby pull bottom wall support cords 54 upwardly to collapse cells 16. Conversely, release of cord lock 70 permits actuator cord 20 to rise, in turn causing the weight of the array of cells to pull downwardly on bottom wall support cords 54, in turn causing block and tackle device 30 to slide away from cord lock 24, and the cells to expand.

Because the use of only one set of beaded cords to actuate the cells results in the mass center of each cell moving up and down with actuation, unlike the prior art, for longer span and therefore heavier blinds it is advantageous to reduce the force that a user must apply to the actuating cords to effect the actuation. In those circumstances, the operating force for lifting all the cell bottoms is too great for comfort (or for secure cord lock function), and it is desirable to employ an actuator cord 20 arrangement that is modified from that shown in FIGS. 1 and 5. Instead of the upper portion of actuator cord 20 being simply doubled upon itself for its full length from safety equalizer 73 up to the curved guide surface of block and tackle device 30, it is reconfigured to provide a two-to-one mechanical advantage. This modified cord configuration may, in one embodiment (not illustrated), be achieved by providing a hole in the immobile base of cord lock 24, and initially passing the “U” bend or bight of the loop in actuator cord 20 upwardly through that hole and then pulling the free ends of that cord through the eye of the “U” above the hole to anchor or ground the bight end of actuator cord 20 to the immovable cord lock base. The two side-by-side free ends of actuator cord 20 are passed around the curved guiding surface of block and tackle device 30, through the locking pawl of cord lock 24 and down to safety equalizer 73. The force balance across block and tackle device 30 divides the force necessary to oppose the cell weights by directing one half to the bight portion of cord 20 that is anchored to the hole in stationary cord lock 24, while the other half is carried by the side-by-side end portions of the looped cord 20 that pass downwardly through the locking pawl of cord lock 24 to safety equalizer 73. Thus, an operator pulling downwardly on actuator cord 20 bears just half of the necessary force, but must pull twice as far to gain that mechanical advantage. However, that distance is acceptable because the amount of travel required of bottom wall actuator cords 54 is merely the height of one cell, as compared to the entire shade height in the case of shade lift cord 18. Tests have shown that for almost all shade sizes (up to 30 square feet), the resulting actuator cord force is below 10 pounds, well within the comfort range of typical users.

It is to be understood that the above description is intended to be illustrative and not restrictive. Many embodiments and applications other than the examples provided would be apparent to those of skill in the art upon reading this description. The scope of the invention should be determined, not with reference to the above description or drawings, but should instead be determined with reference to the appended claims, along with the full scope of equivalents to which such claims are entitled. It is anticipated and intended that future developments will occur in the arts discussed herein, and that the disclosed embodiments will be incorporated into such future embodiments. In sum, it should be understood that the invention is capable of modification and variation and is limited only by the following claims.

1. In a window covering of the type characterized by a plurality of elongated, parallel, hollow and collapsible cells arranged in a substantially vertical plane when installed in a window opening, each of said cells having an upper portion and a lower portion, and each of said cells being selectively collapsible from a fully expanded condition to create an adjustable gap separating each cell from its adjacent cells to thereby provide light and privacy control, the improved cell shape-controlling system comprising:
at least one pair of cell-supporting cords comprising a first support cord supporting the upper portion of each cell and a second support cord supporting the lower portion of each cell;
the collapse and expansion of each cell being accomplished solely by the respective raising and lowering of said second support cord without any movement of said first support cord.

2. The window covering of claim 1 which further comprises vertically spaced lifting formations on each of said first and second support cords, said lifting formations adapted to selectively abut and support from below said cell upper and lower portions, respectively, whereby expansion of each of said cells results from the weight of such cell as the support from said second support cord and its associated lifting formations is lowered.

3. The window covering of claim 2 wherein said lifting formations are secured to said support cords by a crimping operation.

4. The window covering of claim 2 wherein said second support cord may be lowered below the point at which said lower portion of each cell contacts and rests upon said upper portion of the next adjacent lower cell, in which position said lifting formations on said second support cord no longer abut and support said cell lower portions.

5. The window covering of claim 4 wherein said second support cord lifting formations for each of said cells pass through clearance holes in said cell upper portion of the next adjacent lower cell and into the interior of said next adjacent lower cell as each of said cells approaches its fully expanded condition.

6. The window covering of claim 2 wherein each of said cells has first and second pairs of vertically aligned holes to permit passage of said first and second support cords, respectively;
the upper hole of said first pair of holes being located in said cell upper portion and being smaller than said first support cord lifting formations to prevent passage of said first support cord lifting formations there through, and the lower hole of said first pair of holes being located in said cell lower portion and being larger than said first support cord lifting formations to permit passage of said first support lifting formations there through;
the upper hole of said second pair of holes being located in said cell upper portion and being larger than said second support cord lifting formations to permit passage of said second support cord lifting formations there through, and the lower hole of said second pair of holes being located in said cell lower portion and being smaller than said second support cord lifting formations to prevent passage of said second lifters there through.

7. The window covering of claim 6 wherein said upper holes of said first pair of holes and said lower hole of said second pair of holes are sized to provide minimal radial clearance for said support cords.

8. The window covering of claim 1 wherein a cord lock is used to retain said second support cord in place when said cells are not in their fully expanded condition.

9. The window covering of claim 1 which further comprises:
an operator grip connected to said second support cord, by which an operator may control the expansion and contraction of said cells by adjusting the vertical position of said second support cord;
and a block-and-tackle device interposed between and connected to said operator grip and said second support cord lifting formations, whereby the operator-applied force required to lift said cell lower portions to collapse said cells is reduced.

10. In a window covering of the type characterized by a plurality of elongated, parallel, hollow and collapsible cells arranged in a substantially vertical plane when installed in a window opening, each of said cells having an upper portion and a lower portion, control cords for selectively collapsing each of said cells from a fully expanded condition to create an adjustable gap separating each cell from its adjacent cells to thereby provide light and privacy control, the improved cell structure comprising:
a hollow tube formed of flexible, non-stiffened fabric;
said fabric having laminated thereto at least two thermoformable stiffening strips, one extending longitudinally along each of said cell upper and lower portions, said strips being formed with matching transverse cambers to enhance their longitudinal stiffness and to facilitate nesting of adjacent cells when they are in their fully expanded condition.

11. The window covering of claim 10 wherein said cell further comprises a plurality of additional longitudinal stiffening strips are laminated to said fabric to provide stiffening to other portions of the circumference of said fabric tube, said thermoformable stiffening strips and said additional stiffening strips being laterally spaced from each other so that the non-stiffened fabric in the spaces between said strips may function as a living hinge to facilitate controlled expansion and collapse of said cells.

12. The window covering of claim 11 wherein said additional stiffening strips are formed of fabric stiffened by a curable stiffening compound, and wherein said non-stiffened fabric, said additional stiffening strips and said thermoformable stiffening strips are all formed by polymeric materials whose thermal expansion rates are substantially matched to minimize thermal distortion of the completed cells.

13. The window covering of claim 11 wherein said thermoformable stiffening strips are translucent.

14. A method of assembling window covering of the type characterized by a plurality of elongated, parallel, hollow and collapsible cells arranged in a substantially vertical plane when installed in a window opening, each of said cells having an upper portion and a lower portion, control cords passing vertically through said cells and having uniformly spaced lifters secured thereto for supporting portions of each of said cells to thereby selectively collapse or expand said cells and thereby create an adjustable gap separating each cell from its adjacent cells to thereby provide light and privacy control, the method comprising the steps of:
(i) stacking individual cells having vertically aligned pre-formed holes in said upper and lower portions;
(ii) threading said control cords upwardly through said holes of the entire cell stack, said control cords being of substantially uniform diameter along their length and free of any lifting formations thereon until after said threading step has been completed.

15. The assembly method of claim 14 further comprising the steps of:
(iii) after said cord-threading step, raising the topmost cell from said stack;
(iv) securing a lifter to said control cords at a predetermined elevation between said lifted cell and said cell stack, while maintaining said control cords taut between said lifted cell and said stack;
(v) repeating steps (iii) and (iv) until the desired number of cells are supported by lifters secured to said control cords.

16. The method of claim 15 wherein said lifters are secured to said control cords by crimping.

17. The method of claim 15 wherein said control cords are secured at their upper ends to a vertically movable member that moves upwardly through a predetermined distance after each lifter-securing step, thereby raising said attached lifters and the cells supported thereby assuring that said cells and lifters will be uniformly spaced.

18. The method of claim 17 wherein the window covering includes a first control cord and first set of vertically-spaced lifters to support said upper cell portions, and a second control cord and second set of lifters to support said lower cell portions, and wherein said predetermined distance is greater than the fully expanded height of each cell, said lifter-securing step comprising securing a lifter to each of said first and second control cords so that the vertical distance between the two lifters for a given cell corresponds with the desired fully expanded height of a cell.

19. The method of claim 14 wherein each of said cells has first and second pairs of vertically aligned holes to permit passage of said first and second support cords, respectively;
the upper hole of said first pair of holes being located in said cell upper portion and being smaller than said first support cord lifter to prevent passage of said first support cord lifter there through, and the lower hole of said first pair of holes being located in said cell lower portion and being larger than said first support cord lifter to permit passage of said first support lifter there through;
the upper hole of said second pair of holes being located in said cell upper portion and being larger than said second support cord lifter to permit passage of said second support cord lifter there through, and the lower hole of said second pair of holes being located in said cell lower portion and being smaller than said second support cord lifter to prevent passage of said second lifters there through.

20. A method of forming cell for use in a window covering of the type characterized by a plurality of elongated, parallel, hollow and collapsible cells arranged in a substantially vertical plane when installed in a window opening, each of said cells having an upper portion and a lower portion, control cords passing vertically through said cells and having uniformly spaced lifters secured thereto for supporting portions of each of said cells to thereby selectively collapse or expand said cells and thereby create an adjustable gap separating each cell from its adjacent cells to thereby provide light and privacy control, the method comprising the steps of:
(i) providing a supply roll of flexible fabric to which no final coloring has been applied, said rolled fabric being in the form of an elongated strip to which two laterally spaced, longitudinally extending stiffening strips have previously been laminated;
(ii) feeding a continuous length of fabric strip from said supply roll to a printing station where color and/or pattern is applied to the fabric based upon a predetermined set of window covering width, color and pattern specifications;
(iii) punching control cord access holes in said laminated fabric strip at locations appropriate for said predetermined window covering size;
(iv) folding the lateral edges of said fabric strip together and joining said edges together to form a cell of continuous length; and
(v) cutting said continuous cell to predetermined individual cell lengths corresponding to said specified window width, the cut lines being coordinated with the positions of said previously punched cord access holes;
(vi) said method being performed in a continuous and uninterrupted operation from said supply roll until said individual cells have been cut to length ready for assembly into a window covering in accordance with said predetermined specifications.

21. The cell forming method of claim 20 wherein said two stiffening strips are made of thermoformable material and positioned on said fabric strip so that they will form said upper and lower portions of said cell, and said continuous cell forming method comprises the additional step of passing said laminated fabric strip through a thermoforming device that creates matching permanent transverse cambers in said stiffening strips to enhance their longitudinal stiffness and to facilitate nesting of adjacent cells when they are in their fully expanded condition in an assembled window covering.
